(19) United States
(12) Patent Application Publication
(10) Pub. No.: US 2016/0343002 A1
(43) Pub. Date: Nov. 24, 2016

(54) IMPROVEMENTS TO METHOD AND SYSTEM FOR DETECTING COUNTERFEIT CONSUMABLE PRODUCTS

(71) Applicant: Carlos Moises Hernandez Suarez, Colima (MX)

(72) Inventor: Carlos Moises Hernandez Suarez, Colima (MX)

(21) Appl. No.: 15/112,378

(22) PCT Filed: Jan. 16, 2015
(86) PCT No.: PCT/MX2015/000002

§ 371 Date: Jul. 18, 2016

(30) Foreign Application Priority Data
Jan. 16, 2014 (MX) MX/U/2014/000020

(51) Int. Cl. G06Q 30/00; G06K 7/14; G06F 17/30

(52) U.S. Cl. CPC G06Q 30/0185; G06F 17/30528; G06K 7/1417; G06K 7/1413

(57) ABSTRACT

This invention consists of a device that incorporates two IDs: one externally and another internally, which serve to identify if the product is original or counterfeit. The main innovation consist of both IDs being adhered to the surface of the product; one ID is exposed and the other is hidden behind a protective layer of some sort. This layer can only be removed by the owner of the product. This modification allows for any product to be identified as original or not, regardless if it isn't packaged or contained in any way, such as: clothing, footwear, accessories, electronics, tires, mechanical pieces or devices in general. The other innovation is that at least the external ID should provide the user with descriptive information of the product, for example: brand, commercial name, color, size, volume, usage, number of pieces, etc.; which will allow the user to know if the ID corresponds with the product he wishes to acquire.

### FIELD OF THE INVENTION

The device presented in this document is an improvement over the method described in MX/a/2013/005962 “METHOD AND SYSTEM FOR DETECTION OF COUNTERFEIT CONSUMABLES” which was designed to determine if a bottled or packaged product is original or counterfeit. The improvements described in this document enable use in products without packaging, for example: clothing, footwear, accessories, electronics, tires, mechanical pieces or devices in general. The device described in this application is suited for application on bottled or packaged products. This document also presents an improvement to the system to make it more robust in face of possible violations described in detail.

### BACKGROUND

A specific set of definitions will be used throughout this document. They are defined below and are identical to those used by Hernandez Suarez in his application MX/a/2013/005962 “METHOD AND SYSTEM FOR DETECTION OF COUNTERFEIT CONSUMABLES”. These are:

ID: abbreviation of identification, which is a physical mean that contains information, usually numeric or alphanumeric. A classic example of ID is a barcode.

Code: information contained within an ID.

ID Scan: the process of reading or acquire the code from an ID.

Scanning System: a system that includes both hardware and software and can scan the code in an ID. This scanner might or might not transmit the information to third parties automatically.

Database: a system that stores information related to the codes.

Validation: the act of analyzing the code's information from the database. The resulting information can be any response, for example: does the code exist or not in the database, how many times has it been scanned or any information associated to the code.

QR: acronym for “Quick Response.” This ID is bidimensional.

Consumer: any individual that acquires the ownership of the product.

Intermediate consumer: any individual that acquires the ownership of the product, but does not consume it.

End consumer: any individual that acquires the ownership of the product to consume it.

The north-American application Ser. No. 13/643,800 from Pettersson, titled “ANTI-COUNTERFEITING METHOD USING AT LEAST TWO DIFFERENT CODES” consists of a method based on two identifiers (IDs): one located on the product externally and the other internally, which aided by a mobile device that connects to a database, permits the identification of an original or counterfeit product. Said method works as follows: a database contains external and internal ID for every product, and when both are printed externally and internally on an original product, the database assigns an “original” or “new product” status to both IDs. When acquiring the product, the consumer gains access to the internal ID. After scanning this ID, the status of both IDs in the database changes from “original product” to “used product”. This way, any user in possession of a copied product with identical IDs, scans the external ID when attempting to acquire the product and is immediately notified by the database that the internal ID of this product has already been used, which can only be done if another user has gained access to the internal ID from a copy of the product. To summarize, the user can know if the product is authentic simply by scanning the external ID, but scanning the internal ID is what changes the status from “original” to “used.” This method suffers a major flaw, since it is possible for a forger to acquire two original products, copy both external IDs and fabricate multiple counterfeit products, each one with an external ID as an original external ID and another original external ID as an internal ID. This way, any user acquiring a counterfeit product will read the external and internal IDs and the system charged with identifying both ID's will think it is reading the external IDs of two different products. This flaw renders Pettersson's method unfit to accomplish the task for which it was originally designed.

The application MX/a/2013/005962 “METHOD AND SYSTEM FOR DETECTION OF COUNTERFEIT CONSUMABLES” from Hernandez Suarez is different because it asks the user if the scanned ID is internal or external, so the previous ID swapping trick to fool Pettersson's system doesn't work. However, in MX/a/2013/005962 Hernandez's system is presented as an effective method to protect bottled, canned or packaged products, by providing an external ID and an internal ID. The internal ID can only be accessed once the product is opened or uncapped, so it can't be applied several products that aren't packaged, such as: clothing, shoe wear, accessories, electronics, tires, mechanical pieces or devices in general, to name a few. Additionally, some bottled products contain liquids or products intended for human consumption, so its preferable if the internal ID didn't come into direct contact with the contained product. Sometimes, it could also prove difficult to place an ID internally (for instance, in an alcoholic beverage), and a different methodology to identify these products as original or counterfeit would be useful. This application presents a device that implements an improved version of Hernandez's method that allows for appliance in any product, even those that aren't found in a package, bottle or other containers.

On the other hand, there's a chance a for a forger to acquire products of low commercial value, protected by the system described in the application MX/a/2013/00596, and copy or peel both IDs off original products and apply them to fake products with a consumer thinks are of greater value, for example: obtain the IDs of something relatively cheap like a water bottle, remove the IDs and place them on a bottle of perfume, alcohol or medicinal product of much higher commercial value. A user of the system described in MX/a/2013/005962 would not be able to tell that the IDs of a counterfeit product are valid IDs from an authentic product of lower pricing.

This document also proposes that scanning the external ID should provide descriptive information of the product, for instance: brand, commercial name, volume, color, number of pieces contained, etc. This way, the user can easily determine if the scanned ID corresponds to the product he wishes to acquire in the first place. Optionally, its possible for the internal ID to provide this information as well.

### BRIEF SUMMARY OF THE INVENTION

Protect products that aren't bottled, packaged, present difficulty or don't call for internally placed ID. In such a case, both IDs have to be placed on the outside, but one would have to be hidden from sight by a protective layer that can only be removed once you have ownership of the product. Because of this, the visibly exposed ID would still work as an external ID from Hernandez's MX/a/2013/005962 application, and the covered-up ID would serve the same function as an internal ID from the same application because of the protective layer that hides it.

In the MX/a/2013/005962 application, the ID placed inside the package or product is called an Internal ID, and the one placed on the outside is called an External ID. In this application, the internal ID referred to in MX/a/2013/005962 is substituted by an ID placed externally, but its code is not in plain sight because of a protective layer that can only be removed by the owner of the product. In what remains of this document, the ID that is seen in plain sight will be called Exposed ID, while the one concealed by the protective layer will be called Hidden ID.

There's a variety of ways to place both these IDs, for example: the exposed ID and the hidden ID could be on separate labels; they could be on the same side of the same label, or one could be at the front and the other on the reverse side of the label; both IDs could be adhered to the surface of the product or framed by a label that can be attached to the product in multiple different ways, as described in the claims.

### BRIEF DESCRIPTION OF THE DRAWINGS

The figures presented in this application only serve illustrative purposes and don't pretend in any way to be an exhaustive description of the different ways you can place the IDs.

FIG. 1 depicts an example of the device presented here in which both IDs are adhered to the external area of the product but kept separate. In this figure the exposed ID is indicated with (1) and the hidden ID is indicated with (2).

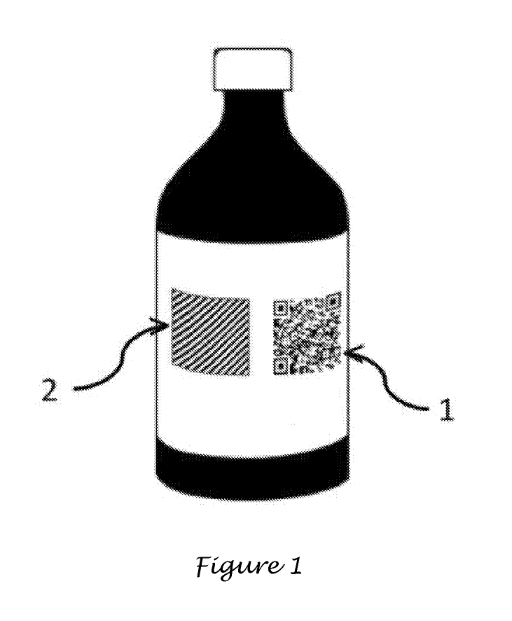

FIG. 2 shows an example of the device presented here in which both IDs are adhered to the external area of the product, un such a way that the hidden ID is underneath the exposed ID. In this figure the exposed ID is indicated with (1) and the hidden ID is indicated with (2), which is behind or underneath the exposed ID.

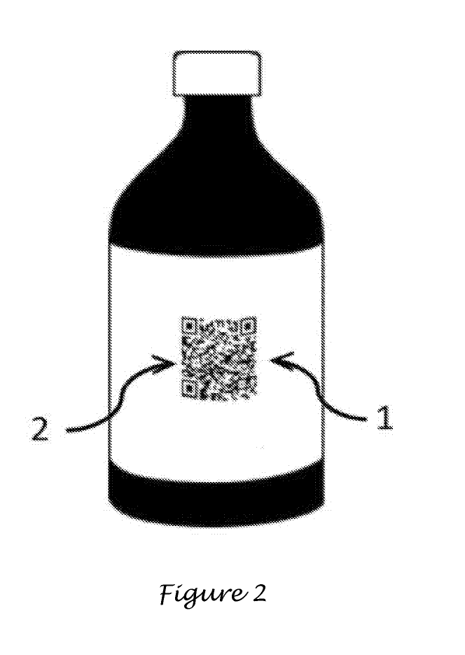

FIG. 3 illustrates an example of the device presented here in which both IDs are contained in a single label that is attached to the product through a physical link (3). In this figure, the exposed ID is indicated with (1) and the hidden ID with (2), which is behind or underneath the exposed ID.

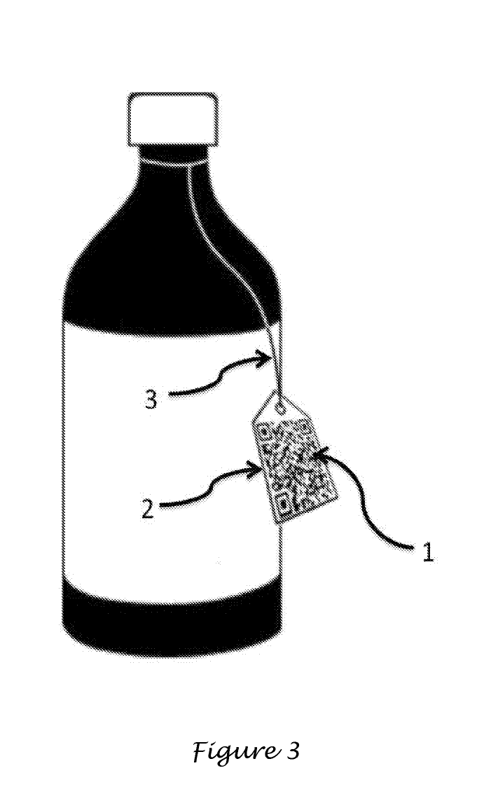

### DETAILED DESCRIPTION OF THE INVENTION

The system consists of a device that implements the method described by Hernandez in the MX/a/2013/005962 application “METHOD AND SYSTEM FOR DETECTION OF COUNTERFEIT CONSUMABLES”, which allows said device to be used on unblotted or unpackaged products. The improvement consists in placing the internal ID described in Hernandez's application on the outside of the product, but hidden by a protective layer that can only be removed by the product's owner.

Because of this, an improved version of the one described in MX/a/2013/005962 is that by reading the external ID the user is provided with information on the product, for instance, brand, commercial name, color, size, volume, use, number of items containing, etc. This will prevent a skilled forger from acquiring an original product of low commercial value, taking both of its IDs and placing them on adulterated or fake product of higher commercial value.

### PREFERRED REALIZATION OF THE INVENTION

Preferably, both exposed and hidden IDs are adhered to the exterior of the product in such a way that its difficult to access the hidden ID without leaving a trace of the access. This scheme is ideal, independently of the IDs being placed together or separate. Its important to note that many different techniques or variations can be done out of this general idea, so you can use different materials, sizes, locations for the IDs, or different types of codes used as IDs. There are also different mechanisms or technologies you can use to link with the database depending on the employed scanning system. However, this application only describes the general characteristics of the system, without being in any way an exhaustive list of all possible adaptations of the methodology exposed here, involving current or future technology. It is also preferable for the product's information to be contained in the database referred to in the MX/a/2013/005962 application.

1. A device for the identification of products, comprising first and second identifications, wherein the first identification is placed on the exterior of a product and capable of being scanned with electronic means.

2. The device of claim 1, wherein both first and second identifications are located in a manner that doesn't require opening the product's package or container in order to access the first and second identifications; and wherein one of the first and second identifications is hidden with a protective layer and the other of the first and second identifications is exposed.

3. The device of claim 2, wherein the first and second identifications are adhered to one or more labels which are linked physically, chemically or electrostatically.

4. The device of claim 3, wherein first identification contains descriptive information about the product.

5. The device of claim 1, wherein consultation of the first identification provides a user with information about the product.

6. The device of claim 1, wherein at least one of the first and second identifications is used to verify information in a database containing the total of emitted and validated codes.

7. The device of claim 2, wherein consultation of the first identification provides a user with information about the product.

8. The device of claim 3, wherein consultation of the first identification provides a user with information about the product.

9. The device of claim 2, wherein at least one of the first and second identifications is used to verify information in a database containing the total of emitted and validated codes.

10. The device of claim 3, wherein at least one of the first and second identifications is used to verify information in a database containing the total of emitted and validated codes.
